(19) United States
(12) Patent Application Publication
(10) Pub. No.: US 2013/0343847 A1
(43) Pub. Date: Dec. 26, 2013

(54) LOADING APPARATUS AND METHOD OF USING SAME

(71) Applicant: Jeffrey M. Freeman, Liberty, MS (US)

(72) Inventor: Jeffrey M. Freeman, Liberty, MS (US)

(21) Appl. No.: 13/926,497

(22) Filed: Jun. 25, 2013

Related U.S. Application Data
(60) Provisional application No. 61/690,292, filed on Jun. 25, 2012.

(51) Int. Cl. B60P 1/43

(52) U.S. Cl. CPC B60P 1/435; B60P 1/436
USPC 414/523; 414/537; 414/812

(57) ABSTRACT

A loading apparatus for installation on a vehicle receiving hitch can include a hitch attachment and a loading ramp. The loading apparatus can be used to transport vehicles such as all terrain vehicles and riding lawn mowers on the beds of pick-up trucks. The horizontal length and vertical height of the hitch attachment can be adjusted to conform to varying sizes and designs of pick-up trucks and tailgates.

### CROSS-REFERENCE TO RELATED APPLICATIONS

This application claims priority to U.S. Provisional Patent Application No. 61/690,292, filed Jun. 25, 2012, which is incorporated herein by reference.

### TECHNICAL FIELD AND BACKGROUND OF THE INVENTION

The present invention relates to a loading apparatus that can be used to load and transport vehicles, such as all terrain vehicles and riding law mowers. One embodiment of the invention comprises an apparatus that is attached to a standard receiving hitch on a pick-up truck or similar vehicle.

Loading ramps are commonly used to load and transport recreational all terrain vehicles, riding law mowers and the like. The loading ramps are typically attached to a receiving hitch at the rear of a pick-up truck or sport utility vehicle, which transports tows the loading ramp with the loaded vehicle thereon to the desired destination.

Because of the variation in size and design of pick-up trucks, sport utility vehicles, and other such vehicles used for transporting all terrain vehicles and the like, there is a need for a loading apparatus that can accommodate such variations in size and design.

### SUMMARY OF THE INVENTION

One object of the present invention is to provide a loading apparatus for loading and transporting all terrain vehicles, riding lawn mowers and similar vehicles. Another object of the present invention is to provide a loading apparatus that can be attached to a receiving hitch on a pick-up truck or similar vehicle. Yet another object of the adjusted horizontally and vertically to accommodate pick-up trucks of varying size and design.

These and other objects of the invention can be achieved in the preferred embodiments of the invention described below. One embodiment of the invention comprises a loading apparatus for installation on a vehicle receiving hitch comprising a lower member having a first section adapted for releasable engagement with the vehicle receiving hitch and extending in substantial horizontal orientation from the receiving hitch, and a second section substantially perpendicular to the first section and extending in substantial vertical orientation from the horizontal section. A substantially elongate intermediate member is moveably attached to the second section of the lower member and extends substantially perpendicular to the second section, such that the intermediate member is moveable along a substantially horizontal plane. A substantially elongate upper member is moveably attached to the intermediate member and extends substantially perpendicular to the intermediate member, such that the upper member has an upper end and a lower end opposite the upper end and is moveable along a substantially vertical plane between the upper and lower ends.

According to another embodiment of the invention, a substantially elongate support member is attached proximate the upper end of the upper member and adapted for attaching a loading ramp thereto.

According to another embodiment of the invention, the support member includes a plurality of attachment members formed thereon for receiving a plurality of fasteners positioned through the loading ramp.

According to another embodiment of the invention, a substantially elongate support member is attached proximate the upper end of the upper member, and a loading ramp adapted for supporting a vehicle thereon is releasably attached to the support member.

According to another embodiment of the invention, a first plurality of attachment members are positioned on the support member for receiving and engaging a plurality of complementary fastening members positioned through the loading ramp and into the attachment members, whereby the loading ramp is releasably attached to the support member.

According to another embodiment of the invention, the loading ramp has a front end proximate the support member, and a rear end distal to the support member, and a second plurality of attachment members are positioned proximate the front end of the loading ramp. Each one of the first plurality of attachment members on the support frame is positioned for corresponding engagement with one of the second plurality of attachment members of the loading ramp, and a fastening member is positioned through each one of the first and second plurality of attachment members, such that the loading ramp is releasably attached to the support member and the loading ramp is pivotable about the elongate fastening members.

According to another embodiment of the invention, the loading ramp comprises a first section proximate the support member, and a second section distal to the support member and moveably attached to the first section, such that the loading ramp is moveable from an expanded position wherein the first and second sections are positioned at an incline for loading a vehicle thereon, to a contracted position wherein the first and second sections reside in substantially vertical orientation.

According to another embodiment of the invention, the first section is attached to the second section by a plurality of hinges.

According to another embodiment of the invention, the hinges are adapted to angle the first and second sections when in the expanded position, such that the first section extends at a less steep incline than the second section.

According to another embodiment of the invention, a support arm extends upwardly from the support member, and a stop member is releasably attached to the support arm and positioned to prevent movement of the loading ramp when in the contracted position.

According to another embodiment of the invention, the lower member includes a first tubular section formed at a top end of the second section of the upper member. The first tubular member receives the intermediate member therein, so that the intermediate member can slidably move within the tubular section of the lower member.

According to another embodiment of the invention, a first plurality of holes are formed in the first tubular section, and a second plurality of holes are formed in the intermediate member, and at least one fastening member is positioned through one of the first plurality of holes and one of the second plurality of holes to releasably attach the intermediate member to the lower member, such that the horizontal length of the loading apparatus can be adjusted by removing the fastening member, sliding the intermediate member to a desired position and repositioning the fastening member through one of the first plurality of holes and a different one of the second plurality of holes.

According to another embodiment of the invention, a second tubular section is formed at a distal end of the intermediate member and receives the upper member therein, such that the upper member can slidably move within the second tubular section.

According to another embodiment of the invention, a third plurality of holes are formed in the second tubular section, and a fourth plurality of holes are formed in the upper member, and a fastening member is positioned through each one of the third plurality of holes and one of the fourth plurality of holes to releasably attach the intermediate member to the upper member, such that the vertical height of the loading apparatus can be adjusted by removing the second fastening member, sliding the upper member to a desired position and repositioning the second fastening member through one of the third plurality of holes and a different one of the second plurality of holes.

According to another embodiment of the invention, a loading apparatus for installation on a receiving hitch of a pick-up truck comprises a substantially L-shaped lower member having a first section adapted for releasable engagement with the vehicle receiving hitch and extending in substantial horizontal orientation from the receiving hitch, and a second section substantially perpendicular to the first section and extending in substantial vertical orientation from the horizontal section. A substantially elongate intermediate member is slidably attached to the second section of the lower member and extends substantially perpendicular to the second section, such that the intermediate member is slidable along a substantially horizontal plane and the horizontal length of the loading apparatus is adjustable. A substantially elongate upper member is slidably attached to the intermediate member and extends substantially perpendicular to the intermediate member. The upper member has an upper end and a lower end opposite the upper end, and is slidable along a substantially vertical plane between the upper and lower ends such that the vertical height of the loading apparatus is adjustable. A substantially elongate support member is attached proximate the upper end of the upper member.

According to another embodiment of the invention, a loading ramp adapted for supporting an all terrain vehicle thereon is releasably attached to the support member.

According to another embodiment of the invention, a loading ramp adapted for supporting a riding lawn mower thereon is releasably attached to the support member.

According to another embodiment of the invention, a method of loading a vehicle onto the bed of a pick-up truck comprises providing a pick-up truck with a receiving hitch attached thereto, and providing a loading apparatus comprising a lower member having a first section adapted for releasable engagement with the vehicle receiving hitch and extending in substantial horizontal orientation from the receiving hitch, and a second section substantially perpendicular to the first section and extending in substantial vertical orientation from the horizontal section. A substantially elongate intermediate member is moveably attached to the second section of the lower member and extends substantially perpendicular to the second section, and the intermediate member is moveable along a substantially horizontal plane. A substantially elongate upper member is moveably attached to the intermediate member and extends substantially perpendicular to the intermediate member. The upper member has an upper end and a lower end opposite the upper end and is moveable along a substantially vertical plane between the upper and lower ends. A substantially elongate support member is attached proximate the upper end of the upper member, and a loading ramp adapted for supporting a vehicle thereon is releasably attached to the support member. The loading ramp comprises a first section proximate the support member, and a second section distal to the support member and hingedly attached to the first section. The lower member to the receiving hitch, and the horizontal length and vertical height of the loading apparatus is adjusted so that the support member and a bed of the pick-up truck are substantially co-planar. The loading ramp is from a contracted position wherein the first and second sections reside in substantially vertical orientation to an expanded position wherein the loading ramp extends from a ground surface to a bed of the pick-up truck. The vehicle is driven up the loading ramp and onto the bed of the pick-up truck.

According to another embodiment of the invention, the loading ramp is moved from the expanded position back to the contracted position.

### BRIEF DESCRIPTION OF THE DRAWINGS

FIG. 1 is a perspective view of a loading apparatus according to a preferred embodiment of the invention;

FIG. 2 is a partial perspective view of the loading apparatus of FIG. 1;

FIG. 3 is another partial perspective view of the loading apparatus of FIG. 1;

FIG. 4 is a side view of the loading apparatus of FIG. 1;

FIG. 5 is an environmental perspective view of the loading apparatus of FIG. 1;

FIG. 6 is an environmental rear perspective view of the loading apparatus of FIG. 1;

FIG. 7 is another environmental rear perspective view of the loading apparatus of FIG. 1;

FIG. 8 is another perspective view of the loading apparatus of FIG. 1;

FIG. 9 is another perspective view of the loading apparatus of FIG. 1; and

FIGS. 10-14 are partial side views of the loading apparatus of FIG. 1.

### DETAILED DESCRIPTION OF PREFERRED EMBODIMENTS OF THE INVENTION AND BEST MODE

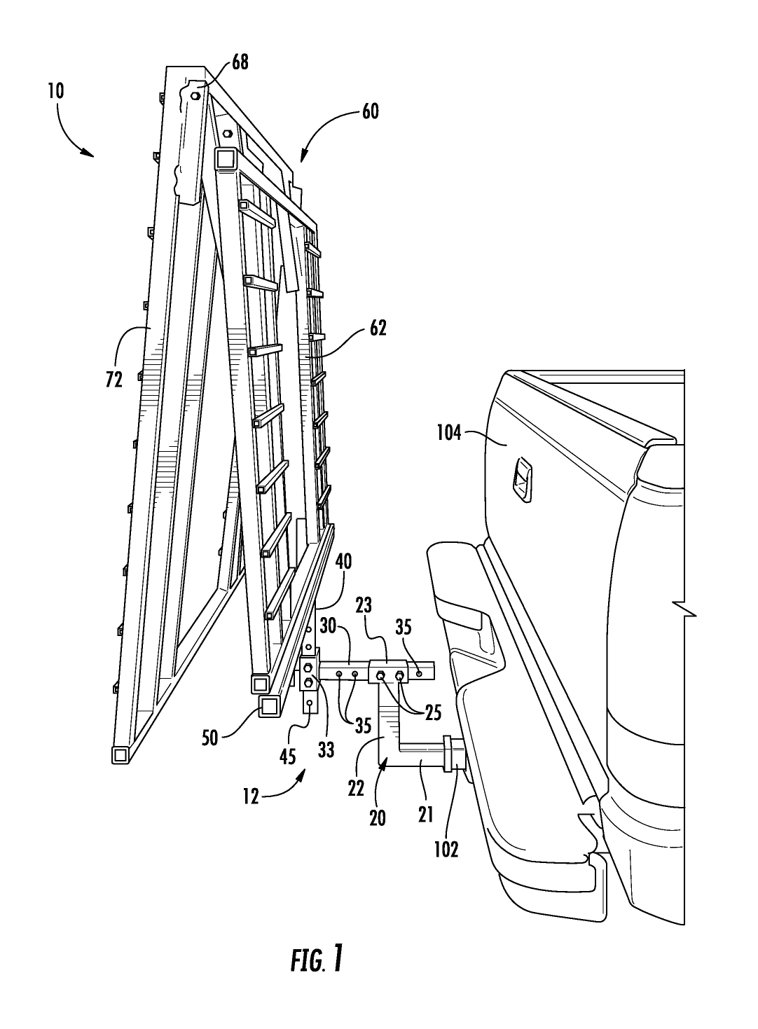

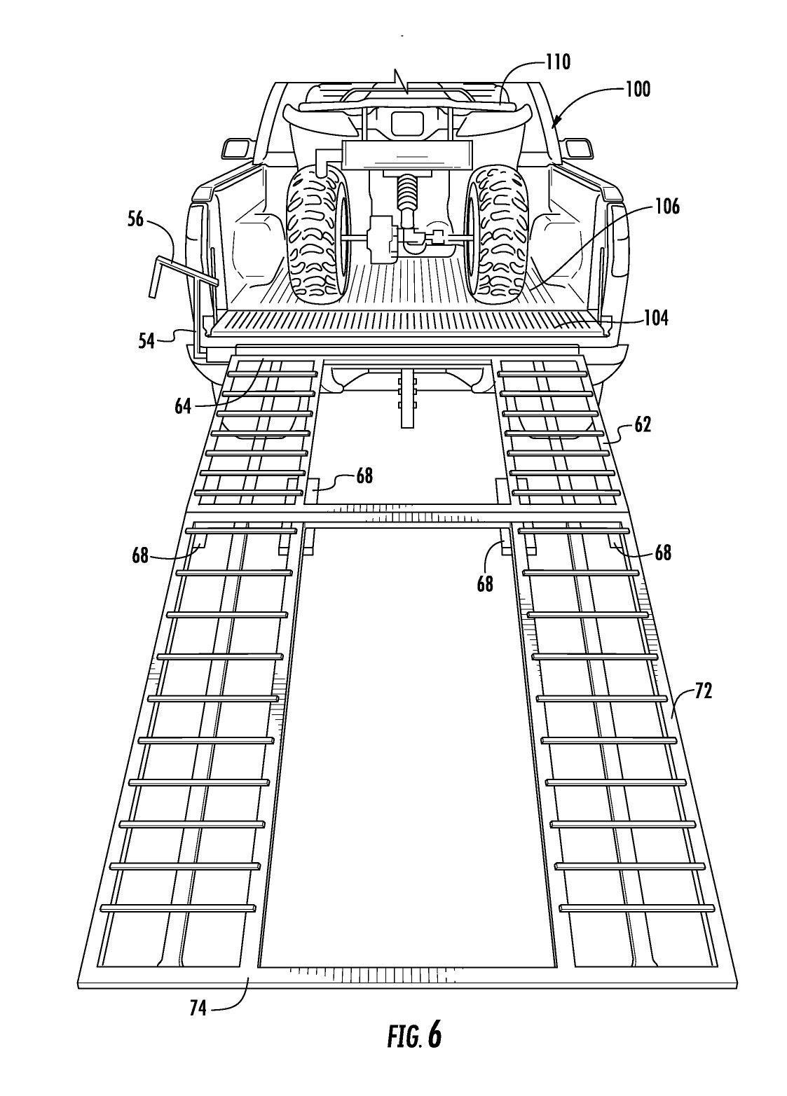

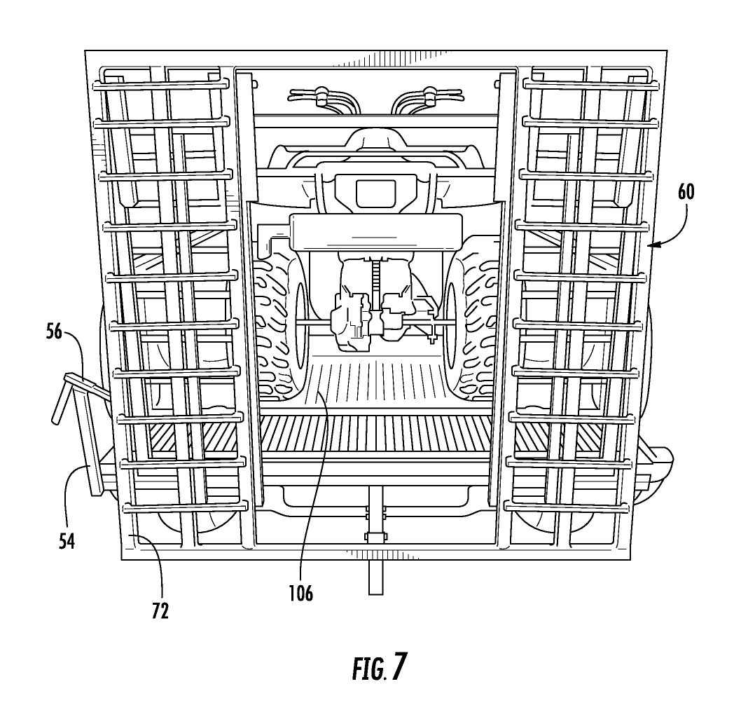

A loading apparatus according to a preferred embodiment of the invention is illustrated in FIGS. 1-10, and shown generally at reference numeral 10. As shown in FIG. 1, the apparatus 10 generally comprises a hitch attachment 12 connected to a loading ramp 60. The hitch attachment 12 is comprised of a substantially L-shaped lower member 20, an elongate intermediate member 30, an elongate upper member 40 and an elongate support member 50.

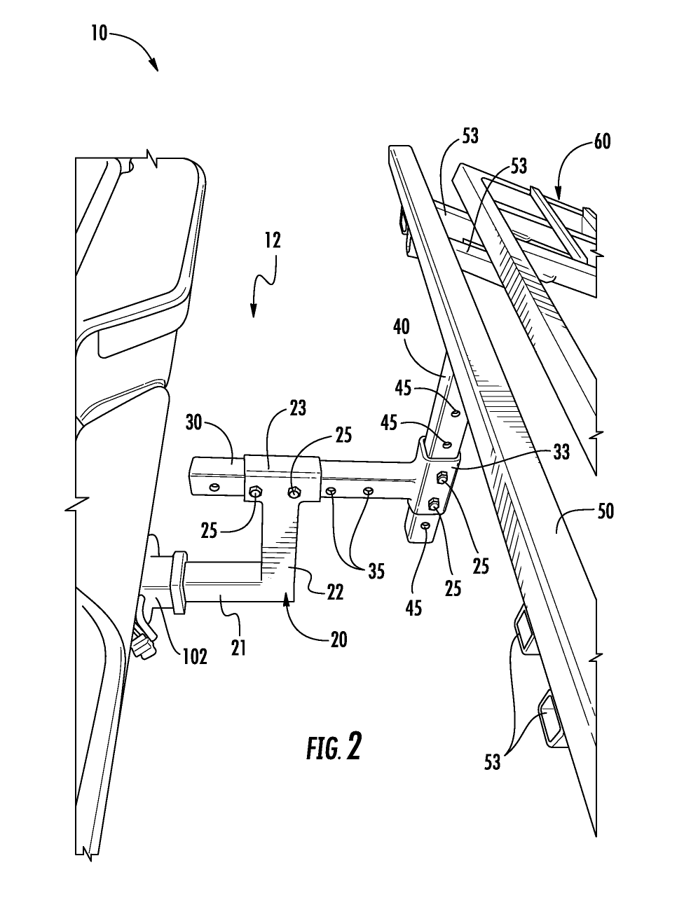

As shown in FIGS. 1 and 2, the L-shaped lower member 20 is comprised of a first elongate section 21 extending horizontally, and a second elongate section 22 extending upwardly at approximately a ninety degree angle from the first section. The horizontal section 21 of the lower member 20 is shaped and sized to fit into and engage a receiving hitch 102 of a pick-up truck 100, as shown in FIG. 2. A horizontally oriented tubular section 23 is formed at the top of the second section 22, as shown in FIG. 2. Two holes are formed in the tubular section 23 to receive fastening members such as bolts 25.

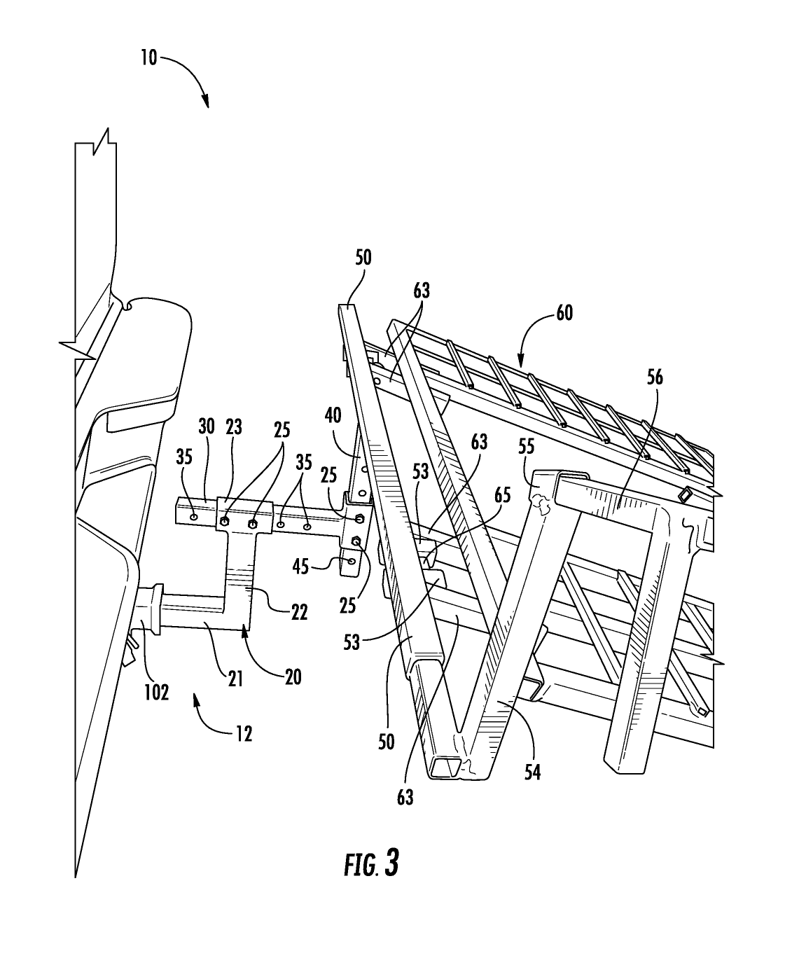

As shown in FIGS. 2 and 3, the elongate intermediate member 30 is positioned through the tubular section 23, and extends horizontally. A plurality of holes 35 are formed in the intermediate member 30 in a line along the length of the intermediate member 30. The intermediate member 30 is positioned within the tubular section 23 such that two of the holes 35 in the intermediate member 30 are aligned with the two holes in the tubular section 23. Bolts 25 are positioned through the two holes in the tubular section 23 and the two aligned holes 35 of the intermediate member 30. A vertically oriented tubular section 33 is formed at the distal end of the intermediate member 30. Two holes are formed in the tubular section 33 to receive fastening members such as bolts 35.

As shown in FIGS. 2-4, the elongate upper member 40 extends vertically through tubular section 33. A plurality of holes 45 are formed in the upper member 40 in a line along the length of the upper member 40. The upper member 40 is positioned within the tubular section 33 such that two of the holes 45 in the upper member 40 are aligned with the two holes in the tubular section 33. Bolts 25 are positioned through the two holes in the tubular section 33 and the two aligned holes 45 of the upper member 45.

As shown in FIG. 2-4, the elongate support member 50 is attached to the top of the upper member 40 and extends horizontally. Four tubular sections 53 are attached on the underside of the support member, as shown in FIG. 2. As shown in FIG. 3, a support arm 54 extends upwardly from the support member 50. An opening 55 is formed at the top of the support arm 54, and a stop member 56 can be positioned through the opening 55, as shown in FIG. 3.

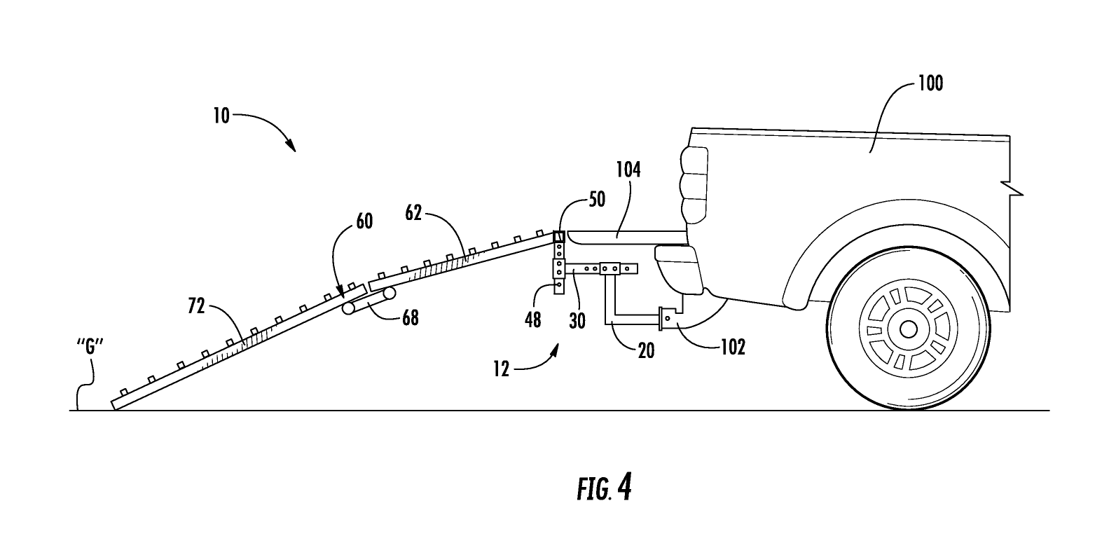

As shown in FIGS. 4-6, the loading ramp 60 comprises a front section 62 proximate the hitch attachment 12, and a rear section 72 distal to the hitch attachment 12 and moveably attached to the front section 62. The front section 62 includes a front bar 64 proximate the hitch attachment 12, and the rear section 72 includes a rear bar 74 distal to the hitch attachment 12. The front section 62 and the rear section 72 are joined by a plurality of hinges 68. As such, the loading ramp 60 is moveable from an expanded position in which the front and rear sections 62, 72 are positioned at an incline, as shown in FIGS. 4-6, to a contracted position in which the front and rear sections 62, 72 reside in a substantially vertical orientation, as shown in FIGS. 7-9.

The hinges 68 are constructed to prevent the front and rear sections 62, 72 from extending all the way to a complete co-planar configuration when in the fully expanded position. Preferably, the hinges 68 are constructed to angle the front and rear sections 62, 72 at about fifteen degrees, such that the front section 62 extends at a less steep incline than the rear section 72 when in the fully expanded position, as shown in FIG. 4.

As shown in FIG. 3, four attachment members 66 extend outwardly from the front bar 64. Each of the attachment members 66 is adjacent to one of the tubular sections 53 of the support member 50. An elongate fastening member such as a bolt can be positioned through the attachment members 66 of the loading ramp 60 and into the tubular sections 53 of the support member 50. As such, the loading ramp 60 is pivotably attached to the support member 50, and the loading ramp 60 can pivot about the bolts.

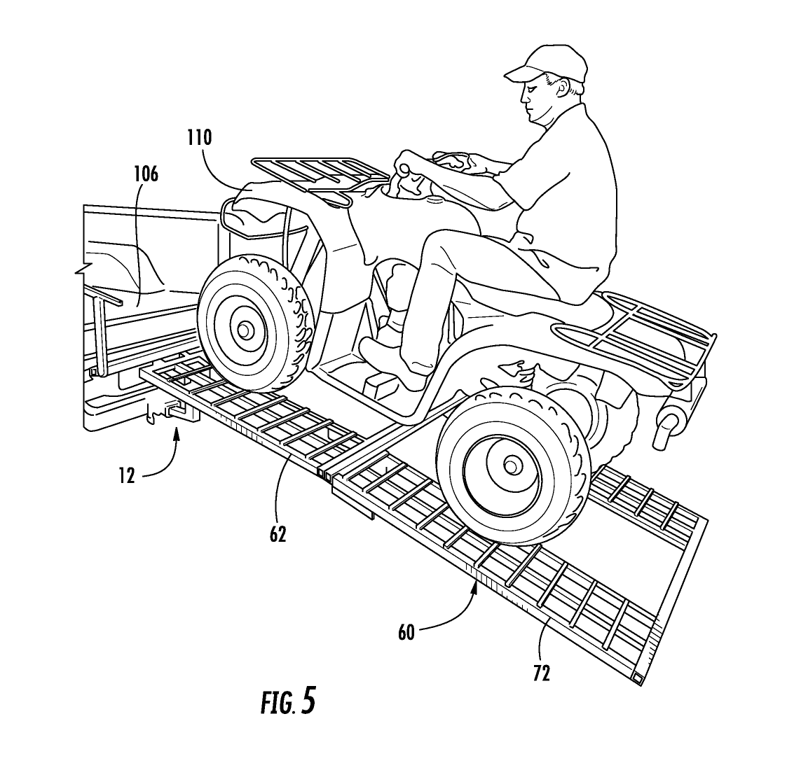

When in the expanded position, the rear bar 74 contacts the ground surface “G”, and the front bar 64 is proximate the tail gate 104 of the pick-up truck when the tail gate 104 is in the fully lowered position. The loading ramp 60 extends from the ground “G” to proximate the lowered tail gate 104 of the pick-up truck 100. As shown in FIG. 4, the front section 62 of the loading ramp 60 is elevated at a slight angle, preferably about fifteen degrees, in relation to the rear section 72. As such, the front section 62 is closer to being level with the horizontal plane of the tailgate 104 than the rear section 72. A vehicle to be transported such as an all terrain vehicle (ATV) 110 can be driven up the loading ramp and into the bed 106 of the pick-up truck, as shown in FIG. 5. The slight angle of the loading ramp 60 at the joining of the front and rear sections 62, 72 reduces the incline of the loading ramp 60 proximate the pick-up truck tailgate 104, as shown in FIG. 4.

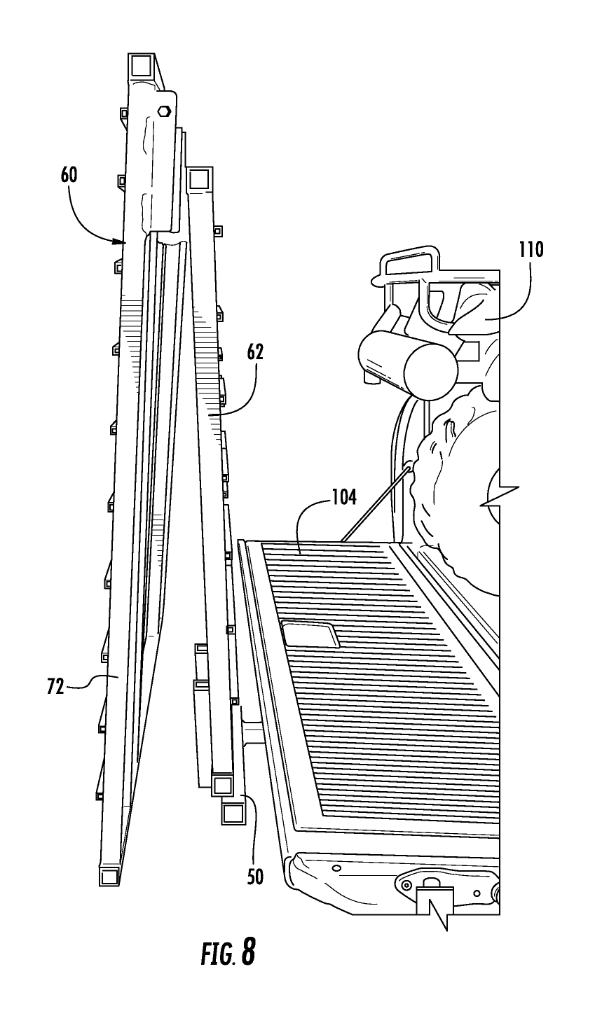

After the ATV 110 has been loaded on the pick-up truck 100, the loading ramp 60 can be moved into the contracted position, as shown in FIGS. 7-9, for easy transport. As shown in FIG. 9, the stop member 56 can be inserted through the opening 55 of the support arm 54, and is positioned adjacent the front section 62 of the loading ramp 60, between the front section 62 and rear section 72. As such, the stop member 56 prevents loading ramp from moving back towards the expanded position during transport.

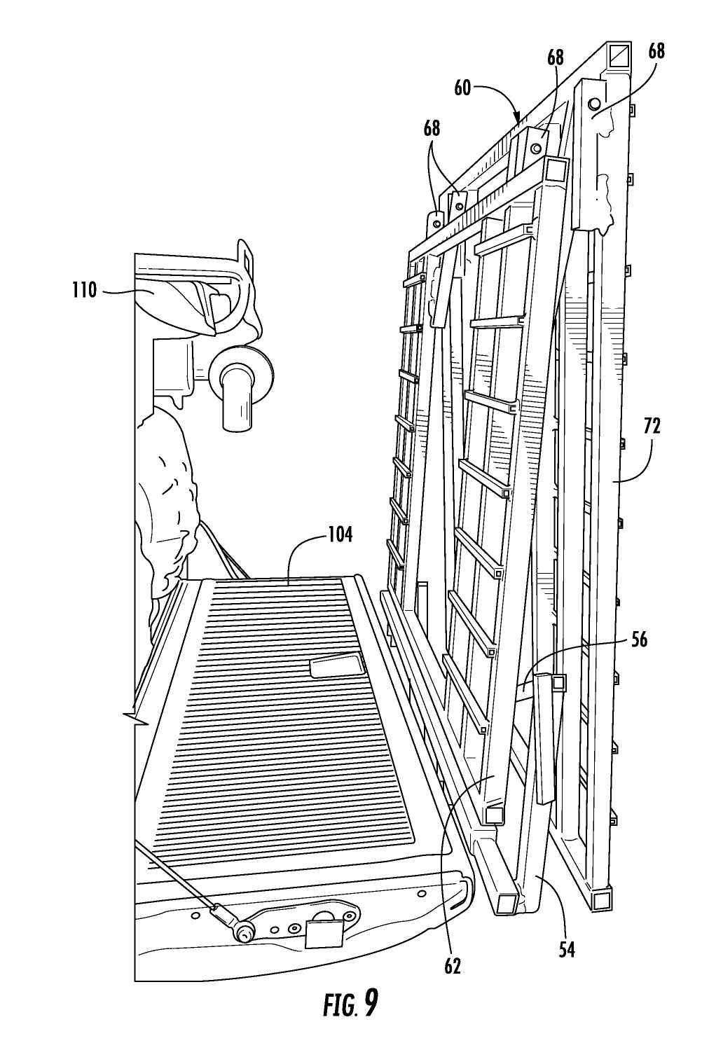

The horizontal length and vertical height of the hitch attachment 12 are adjustable. Preferably, the horizontal length and vertical height are adjusted such that the support member 50 resides in the same horizontal plane as the pick-up tailgate 104 when the tailgate 104 is in the fully lowered position, as shown in FIG. 4. As shown in FIGS. 10-11, the total horizontal length of the hitch attachment 12 can be decreased by removing the bolts 25 from the holes 35a, 35b in the intermediate member, sliding the intermediate member 30 forward (toward the pick-up truck 100), and repositioning the bolts 25 in holes 35d, 35e proximate to the upper member 40, as shown in FIG. 11. The horizontal length can be increased by removing the bolts 25, sliding the intermediate member 30 rearward (away from the pick-up truck 100), and replacing the bolts 25 in holes 35 35a, 35b distal the upper member 40, as shown in FIG. 11.

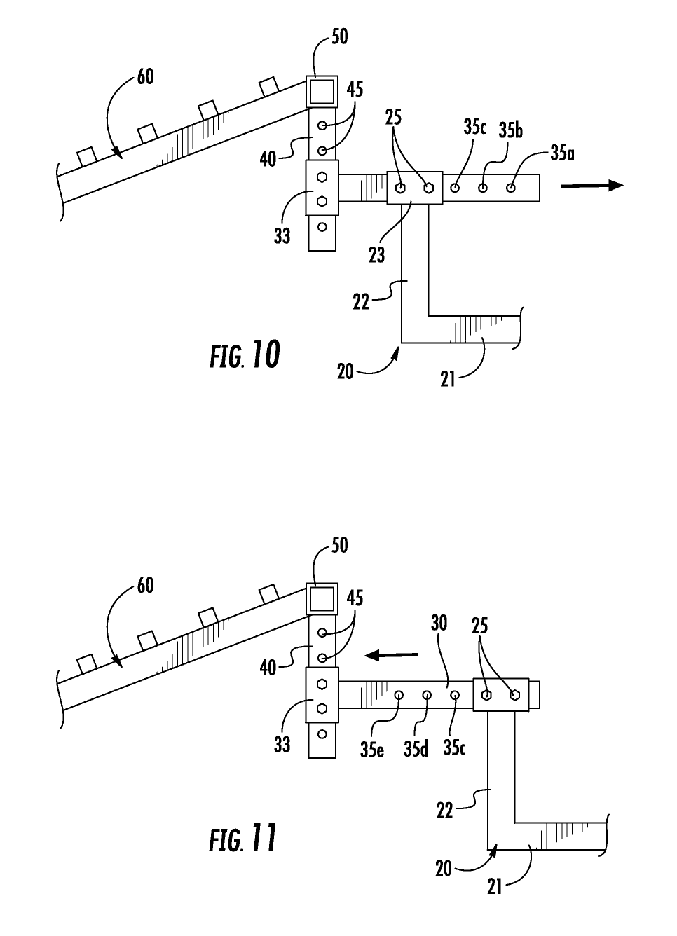

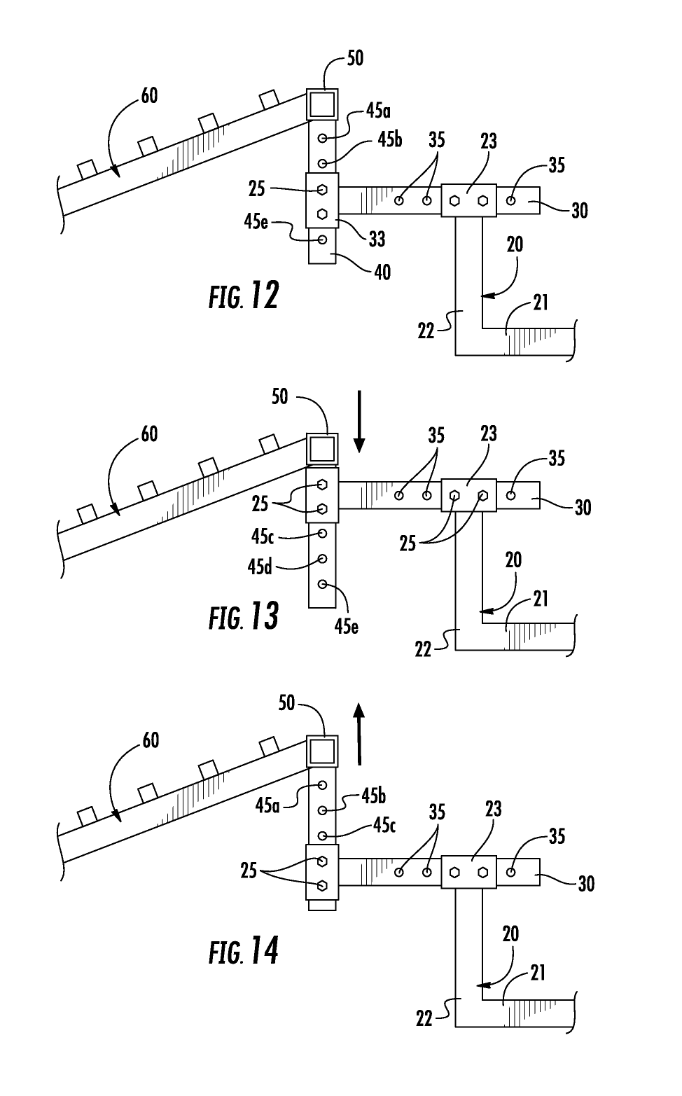

As shown in FIGS. 12-13, the vertical height of the hitch attachment 12 can be decreased, by removing bolts 25 from the holes 45c, 45d in the upper member 40, sliding the upper member downwardly, and repositioning the bolts 25 in holes 45a, 45b proximate the top of the upper member, shown in FIG. 13. As shown in FIGS. 13-14, the vertical height of the hitch attachment 12 can be increased by removing the bolts 35 from the holes 45a, 45b, sliding the upper member 40 upwardly, and repositioning the bolts 35 in holes 45d, 45e proximate the bottom of the upper member 40, as shown in FIG. 14.

Such adjustment allows for the loading apparatus 10 to be used with pick-up trucks and pick-up tailgates of varying size and design. For example, the vertical height of the hitch attachment 12 can be increased so that the loading ramp 60 can reach a pick-up tailgate that sits relatively high up. Also, the horizontal length of the hitch attachment 12 can be increased to accommodate a relatively longer pick-up tailgate.

The hitch attachment 12 can be made of 1.5 inch steel tubing, or other suitable material. The loading ramp 60 can be made of 1.25 inch aluminum tubing, or other suitable material. The loading ramp 60 is preferably seventy-four inches long and fifty inches wide.

A loading apparatus and method of using same are described above. Various changes can be made to the invention without departing from its scope. The above description of the preferred embodiments and best mode of the invention are provided for the purpose of illustration only and not limitation—the invention being defined by the claims and equivalents thereof.

What is claimed is:

1. A loading apparatus for installation on a vehicle receiving hitch comprising:
(a) a lower member having a first section adapted for releasable engagement with the vehicle receiving hitch and extending in substantial horizontal orientation from the receiving hitch, and a second section substantially perpendicular to the first section and extending in substantial vertical orientation from the horizontal section;
(b) a substantially elongate intermediate member moveably attached to said second section of the lower member and extending substantially perpendicular to the second section, wherein the intermediate member is moveable along a substantially horizontal plane; and
(c) a substantially elongate upper member moveably attached to the intermediate member and extending substantially perpendicular to the intermediate member, wherein the upper member has an upper end and a lower end opposite the upper end and is moveable along a substantially vertical plane between the upper and lower ends.

2. The loading apparatus according to claim 1, further comprising a substantially elongate support member attached proximate the upper end of the upper member and adapted for attaching a loading ramp thereto.

3. The loading apparatus according to claim 2, wherein the support member includes a plurality of attachment members formed thereon for receiving a plurality of fasteners positioned through the loading ramp.

4. The loading apparatus according to claim 1, further comprising:
(a) a substantially elongate support member attached proximate the upper end of the upper member; and
(b) a loading ramp adapted for supporting a vehicle thereon releasably attached to the support member.

5. The loading apparatus according to claim 4, further comprising a first plurality of attachment members positioned on the support member for receiving and engaging a plurality of complementary fastening members positioned through the loading ramp and into the attachment members, whereby the loading ramp is releasably attached to the support member.

6. The loading apparatus according to claim 5, wherein the loading ramp has a front end proximate the support member, and a rear end distal to the support member, and includes a second plurality of attachment members positioned proximate the front end of the loading ramp, wherein each one of the first plurality of attachment members on the support frame is positioned for corresponding engagement with one of the second plurality of attachment members of the loading ramp, and further comprising a plurality of elongate fastening members, wherein each one of the fastening members is positioned through one of the first and second plurality of attachment members, whereby the loading ramp is releasably attached to the support member and the loading ramp is pivotable about the elongate fastening members.

7. The loading apparatus according to claim 4, wherein the loading ramp comprises a first section proximate the support member, and a second section distal to the support member and moveably attached to the first section, whereby the loading ramp is moveable from an expanded position wherein the first and second sections are positioned at an incline for loading a vehicle thereon, to a contracted position wherein the first and second sections reside in substantially vertical orientation.

8. The loading apparatus according to claim 7, wherein the first section is attached to the second section by a plurality of hinges.

9. The loading apparatus according to claim 7, wherein the hinges are adapted to angle the first and second sections when in the expanded position, wherein the first section extends at a less steep incline than the second section.

10. The loading apparatus according to claim 7, further comprising a support arm extending upwardly from the support member, and a stop member releasably attached to the support arm and positioned to prevent movement of the loading ramp when in the contracted position.

11. The loading apparatus according to claim 1, wherein the lower member comprises a first tubular section formed at a top end of the second section of the upper member, and receiving the intermediate member therein, whereby the intermediate member slidably moves within the tubular section of the lower member.

12. The loading apparatus according to claim 11, wherein a first plurality of holes are formed in the first tubular section, and a second plurality of holes are formed in the intermediate member, and further comprising at least one fastening member positioned through one of the first plurality of holes and one of the second plurality of holes to releasably attach the intermediate member to the lower member, whereby the horizontal length of the loading apparatus can be adjusted by removing the fastening member, sliding the intermediate member to a desired position and repositioning the fastening member through said one of the first plurality of holes and a different one of the second plurality of holes.

13. The loading apparatus according to claim 12, further comprising a second tubular section formed at a distal end of the intermediate member and receiving the upper member therein, whereby the upper member slidably moves within the second tubular section.

14. The loading apparatus according to claim 13, wherein a third plurality of holes are formed in the second tubular section, and a fourth plurality of holes are formed in the upper member, and further comprising a second fastening member positioned through one of the third plurality of holes and one of the fourth plurality of holes to releasably attach the intermediate member to the upper member, whereby the vertical height of the loading apparatus can be adjusted by removing the second fastening member, sliding the upper member to a desired position and repositioning the second fastening member through said one of the third plurality of holes and a different one of the second plurality of holes.

15. A loading apparatus for installation on a receiving hitch of a pick-up truck comprising:
(a) a substantially L-shaped lower member having a first section adapted for releasable engagement with the vehicle receiving hitch and extending in substantial horizontal orientation from the receiving hitch, and a second section substantially perpendicular to the first section and extending in substantial vertical orientation from the horizontal section;
(b) a substantially elongate intermediate member slidably attached to said second section of the lower member and extending substantially perpendicular to the second section, wherein the intermediate member is slidable along a substantially horizontal plane whereby the horizontal length of the loading apparatus is adjustable;
(c) a substantially elongate upper member slidably attached to the intermediate member and extending substantially perpendicular to the intermediate member, wherein the upper member has an upper end and a lower end opposite the upper end and is slidable along a substantially vertical plane between the upper and lower ends whereby the vertical height of the loading apparatus is adjustable; and
(d) a substantially elongate support member attached proximate the upper end of the upper member.

16. The loading apparatus of claim 15, further comprising a loading ramp adapted for supporting an all terrain vehicle thereon releasably attached to the support member.

17. The loading apparatus of claim 15, further comprising a loading ramp adapted for supporting a riding lawn mower thereon releasably attached to the support member.

18. The loading apparatus according to claim 15, wherein the lower member comprises a first tubular section formed at a top end of the second section of the upper member, and receiving the intermediate member therein, whereby the intermediate member slidably moves within the tubular section of the lower member; and further comprising a second tubular section formed at a distal end of the intermediate member and receiving the upper member therein, whereby the upper member slidably moves within the second tubular section.

19. A method of loading a vehicle onto the bed of a pick-up truck comprising:
(a) providing a pick-up truck with a receiving hitch attached thereto;
(b) providing a loading apparatus comprising:
(i) a lower member having a first section adapted for releasable engagement with the vehicle receiving hitch and extending in substantial horizontal orientation from the receiving hitch, and a second section substantially perpendicular to the first section and extending in substantial vertical orientation from the horizontal section,
(ii) a substantially elongate intermediate member moveably attached to said second section of the lower member and extending substantially perpendicular to the second section, wherein the intermediate member is moveable along a substantially horizontal plane,
(iii) a substantially elongate upper member moveably attached to the intermediate member and extending substantially perpendicular to the intermediate member, wherein the upper member has an upper end and a lower end opposite the upper end and is moveable along a substantially vertical plane between the upper and lower ends,
(iv) a substantially elongate support member attached proximate the upper end of the upper member, and
(v) a loading ramp adapted for supporting a vehicle thereon releasably attached to the support member and comprising a first section proximate the support member, and a second section distal to the support member and hingedly attached to the first section,
(b) attaching the lower member to the receiving hitch;
(c) adjusting the horizontal length and vertical height of the loading apparatus so that the support member and a bed of the pick-up truck are substantially co-planar;
(d) moving the loading ramp from a contracted position wherein the first and second sections reside in substantially vertical orientation to an expanded position wherein the loading ramp extends from a ground surface to a bed of the pick-up truck;
(e) driving the vehicle up the loading ramp and onto the bed of the pick-up truck.

20. The method of claim 19, further comprising the step of moving the loading ramp from the expanded position to the contracted position.
